(19) United States
(12) Patent Application Publication
(10) Pub. No.: US 2019/0043289 A1
(43) Pub. Date: Feb. 7, 2019

(54) OFFLINE LOCK SYSTEM AND METHOD THEREOF

(71) Applicant: Jeff Cahill, Castle Rock, CO (US)

(72) Inventor: Jeff Cahill, Castle Rock, CO (US)

(21) Appl. No.: 15/401,016

(22) Filed: Jan. 7, 2017

Related U.S. Application Data
(60) Provisional application No. 62/275,913, filed on Jan. 7, 2016.

(51) Int. Cl. G07C 9/00

(52) U.S. Cl. CPC G07C 9/00309; E05B 2047/0058; G07C 9/00904

(57) ABSTRACT

An offline lock system includes at least one offline lock installed on a door to allow the door to lock and unlock, at least one lock updater disposed within a predetermined range of the at least one offline lock to communicate with the at least one offline lock, and an access control system to communicate with the at least one lock updater such that the at least one lock updater transmits information to the at least one offline lock to update the at least one offline lock.

### CROSS-REFERENCE TO RELATED APPLICATIONS

This application claims priority under 35 USC § 120 from U.S. Provisional Application No. 62/275,913, filed on Jan. 7, 2016, in the United Stated Patent and Trademark Office, the disclosure of which is incorporated herein in its entirety by reference.

### BACKGROUND OF THE INVENTION

### 1. Field of the Invention

The present general inventive concept relates to an offline lock system and method thereof.

### 2. Description of the Related Art

There are various types of locks being used conventionally to secure buildings and doors within the buildings. Such conventional locks include online locks, wireless locks, and offline locks.

Online locks are networked with the rest of a facility's access control system, so decision-making is done in real-time on a central hub, rather than at a door. These online locks provide greater capabilities than offline locks, including remote management, automatic alerts, and different user access levels. Online locks can be either wired or wireless, depending on an end-user's needs.

Wireless locks use wireless protocol to communicate with a system's central hub. Wireless locks provide an added level of flexibility, as they can be quickly and easily added to an access control solution without the significant time investment involved with running wire. An historical disadvantage of online wireless locks is that there is greater potential of losing system communication with the server, which can be a problem when security is a risk.

Offline locks are battery-operated, stand-alone units, so they don't require wiring to a system's central processing unit (CPU). Since offline locks aren't network-enabled, they represent a much more affordable solution for many end users, and they can be added to an existing access control system.

At present, offline locks are significantly cheaper than online locks. Also, offline locks use significantly less battery power than online wireless locks, and therefore require less frequent battery replacement.

However, offline locks cannot be accessed from a central hub, and therefore require a user to come within range of the offline lock to change configurations and settings thereof. As such, in a building of 200 locks, for example, the user would have to come within range of each individual lock to change configurations or settings thereof, which is inconvenient and time-consuming.

Online locks, in contrast, allow a user to make changes to configurations and settings thereof from a central hub, thereby enhancing convenience for the user, while duly saving time. However, since the online wireless locks are all connected to a network, they are constantly draining battery power, and therefore require frequent battery replacement.

In summary, online wireless locks are expensive and battery-draining, but allow for easy configuration and manipulation from a central hub, while offline locks are cheaper and battery-saving, but do not allow for easy configuration and manipulation from a central hub.

The expensive online locks (typically $3000 to $5000 per door) are most commonly connected by wire/cable or wireless (Wi-Fi). As such, “online locks,” due to wiring or due to wireless (Wi-Fi), currently require power. Therefore, electricians are typically required for lock installation, system engineers are required to design the system, and trained service technicians are required to install long wire/cable runs from these on-line locks back to a controller or server. Wireless (Wi-Fi) systems are basically no less expensive than wired systems because online wireless locks require special components, such as repeaters or range-extenders, to be installed in strategic areas to keep “powered locks” on-line.

Currently, there does not exist any other offline lock system (such as a BLUETOOTH distribution-type system or a BLUETOOTH mesh-type system) that provides most of the functionality of an expensive online lock system by utilizing offline battery-powered locks, by temporarily “waking up” power momentarily to the offline locks to allow communication between the offline locks and a server.

Therefore, there is a need for an offline lock system that allows a plurality of locks to have temporary, direct communication to a server through a Lock Updater, such that the offline lock system is affordable ($300 to $500/door), easily installable, easily updatable, secure, user friendly, and energy-efficient.

### SUMMARY

The present general inventive concept provides an offline lock system having functionality of an online lock system, while maintaining efficiency and cost-effectiveness of a conventional offline lock system.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing an offline lock system, including at least one offline lock installed on a door to allow the door to lock and unlock, at least one lock updater disposed within a predetermined range of the at least one offline lock to communicate with the at least one offline lock an access control system to communicate with the at least one lock updater such that the at least one lock updater transmits information to the at least one offline lock to update the at least one offline lock.

The at least one offline lock may include a sensor to sense a predetermined condition of at least one of the door and the at least one offline lock, a receiver to receive a signal including the information from the at least one lock updater, and a transmitter to transmit a signal with other information to the at least one lock updater.

The at least one offline lock may switch from a low power mode to an online mode in response to at least one of the sensed predetermined condition and the signal received from the at least one lock updater.

The at least one offline lock may be updated while in the online mode, and the at least one offline lock may switch from the online mode to the low power mode after the update is completed.

The transmitter may transmit the signal with the other information to the at least one lock updater in response to the sensed predetermined condition, and the at least one lock updater may transmit the other information to the access control system.

The predetermined condition may include at least one of the door being ajar for a particular time period, batteries within the at least one offline lock having low power, and an unauthorized user attempting to unlock the at least one offline lock.

The access control system may select a closest one of the at least one lock updater with respect to the at least one offline lock that requires an update.

The at least one lock updater may communicate with the at least one offline lock using BLUETOOTH LOW ENERGY (BLE).

The access control system may include a storage unit to store at least one of information regarding the at least one offline lock identification and/or profile data of authorized users, identification and/or profile data of unauthorized users, commands to control user access to the access control system, commands to control user access to the at least one offline lock, commands to control the at least one offline lock, status types of the at least one offline lock, and programs to allow control of the at least one lock updater and the at least one offline lock, and an input unit to allow a user to input information to change a setting of the at least one offline lock, update the at least one offline lock, and change access information of the at least one offline lock.

The offline lock system may further include a mobile device to allow a user to access and control the access control system remotely.

The foregoing and/or other features and utilities of the present general inventive concept may also be achieved by providing a method of updating an offline lock system, the method including transmitting a first signal and first information from an access control system to a selected lock updater, transmitting a second signal and second information via Bluetooth communication from the selected lock updater to at least one of a plurality of offline locks, switching the at least one of the plurality of offline locks from a low power mode to an online mode in response to the at least one of the plurality of offline locks receiving the second signal via Bluetooth communication, updating at least one setting of the at least one of the plurality of the offline locks based on the second information received from the selected lock updater, and switching the at least one of the plurality of offline locks from the online mode to the low power mode after the update.

### BRIEF DESCRIPTION OF THE DRAWINGS

These and/or other features and utilities of the present general inventive concept will become apparent and more readily appreciated from the following description of the embodiments, taken in conjunction with the accompanying drawings of which:

FIG. 1 is a view schematically illustrating an offline lock system according to an exemplary embodiment of the present general inventive concept;

FIG. 2 is a detailed diagram of an ACS of FIG. 1, according to an exemplary embodiment of the present general inventive concept;

FIG. 3 is a detailed diagram of a lock updater of FIG. 1, according to an exemplary embodiment of the present general inventive concept;

FIG. 4 is a detailed diagram of an offline lock of FIG. 1, according to an exemplary embodiment of the present general inventive concept;

FIG. 5 is a view illustrating a user attempting to electronically open an offline lock, according to an exemplary embodiment of the present general inventive concept.

FIG. 6 illustrates a method of changing a setting of at least one of the plurality of offline locks within the offline lock system, according to an exemplary embodiment of the present general inventive concept; and

FIG. 7 illustrates an offline lock system according to another exemplary embodiment of the present general inventive concept.

### DETAILED DESCRIPTION OF THE PREFERRED EMBODIMENTS

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like or similar elements throughout the description of the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

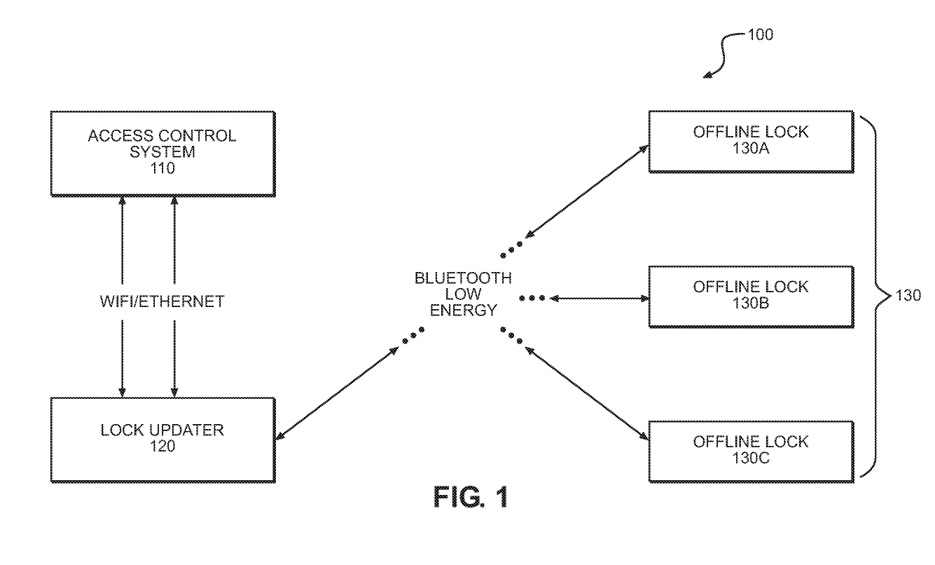

FIG. 1 is a view schematically illustrating an offline lock system 100 according to an exemplary embodiment of the present general inventive concept.

The offline lock system 100 may include an access control system (ACS) 110, a lock updater 120, and an offline lock 130. As illustrated in FIG. 1, the offline lock 130 may be provided in plurality, as illustrated as an offline lock 130a, an offline lock 130b, and an offline lock 130c. However, the offline lock 130 and will be referenced interchangeably both singularly and in plurality hereinafter, as either the offline lock 130 or the plurality of offline locks 130.

The ACS 110 may include a server, computer, or any other type of computing device.

The ACS 110 may include a device capable of wireless or wired communication between other wireless or wired devices. Wireless and wired communications of the ACS 110 may include wi-fi, wi-fi direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, Ethernet, etc., but are not limited thereto. The ACS 110 may communicate at frequencies ranging from 0.001 MHz through 3000 MHz, but is not limited thereto.

The present general inventive concept will be described to include the ACS 110 as having Wi-Fi and Ethernet connectivity, so that signals and information may be transmitted between the ACS 110 and the lock updater 120.

The ACS 110 may receive input from a user via an input unit 110. The input may include commands to access the offline lock 130, to control the offline lock 130, to update the offline lock 130, to monitor the offline lock 130, or perform any function desired regarding the offline lock 130.

The lock updater 120 may include a device capable of wireless or wired communication between other wireless or wired devices. Wireless and wired communications of the lock updater 120 may include wi-fi, wi-fi direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication, USB, Firewire, Ethernet, etc., but are not limited thereto. The lock updater 120 may communicate at frequencies ranging from 0.001 MHz through 3000 MHz, but is not limited thereto.

A plurality of lock updaters 120 may be located on different floors or within a BLE range of various offline locks 130.

The lock updater 120 may be installed and/or located within a wall, within a ceiling, in a closet, in a predetermined area, etc., but is not limited thereto.

The lock updater 120 may receive signals and information from the ACS 110, based on an input of a user, and then may send signals and information via BLE to the offline lock 130.

The offline lock 130 may include a device capable of wireless or wired communication between other wireless or wired devices. Wireless and wired communications of the offline lock 130 may include wi-fi, wi-fi direct, infrared (IR) wireless communication, satellite communication, broadcast radio communication, Microwave radio communication, Bluetooth, Bluetooth Low Energy (BLE), Zigbee, near field communication (NFC), and radio frequency (RF) communication (e.g., RFID), USB, Firewire, Ethernet, etc., but are not limited thereto. The lock updater 120 may communicate at frequencies ranging from 0.001MHz through 3000 MHz, but is not limited thereto.

The offline lock 130 may be in a sleep mode until it receives a signal to “wake up” from the lock updater 120. While the offline lock 130 is in the sleep mode, battery power is conserved.

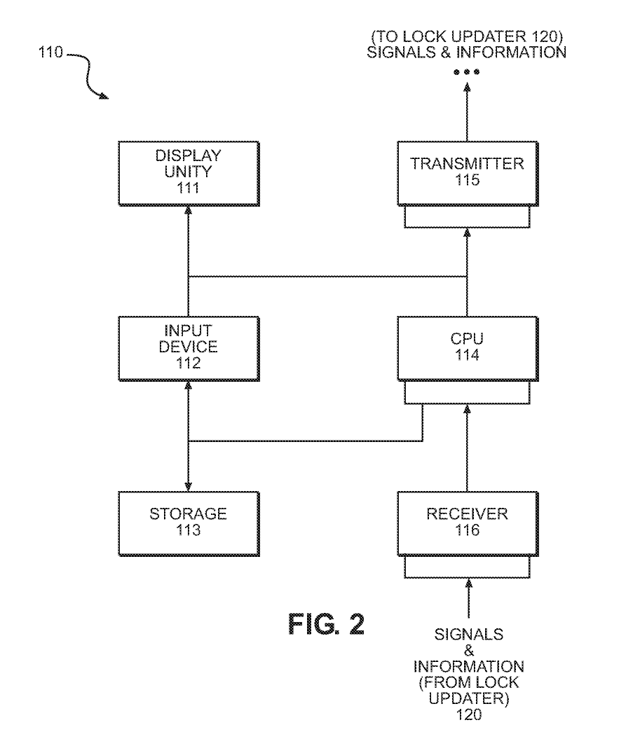

FIG. 2 is a detailed diagram of the ACS 110 of FIG. 1, according to an exemplary embodiment of the present general inventive concept.

The ACS 110 may include components such as a display unit 111, an input device 112, a storage unit 113, a central processing unit (CPU) 114, a transmitter 115, and a receiver 116.

The display unit 111 may include a plasma screen, an LCD screen, a light emitting diode (LED) screen, an organic LED (OLED) screen, a computer monitor, a hologram output unit, a sound outputting unit, or any other type of device that visually or aurally displays data.

The input device 112 may include a keyboard, a mouse, a trackball, a touchpad, a touch-screen, a stylus, a keypad, a proximity sensor, or any other type of device that receives a user input, or any combination of the aforementioned input devices 112.

The storage unit 113 may include a random access memory (RAM), a read-only memory (ROM), a hard disk, a flash drive, a database connected to the Internet, cloud-based storage, Internet-based storage, or any other type of storage unit.

The CPU 114 may include electronic circuitry to carry out instructions of a computer program by performing basic arithmetic, logical, control and input/output (I/O) operations specified by the instructions. The CPU 114 may include an arithmetic logic unit (ALU) that performs arithmetic and logic operations, processor registers that supply operands to the ALU and store the results of ALU operations, and a control unit that fetches instructions from memory and “executes” them by directing the coordinated operations of the ALU, registers and other components. The CPU 114 may also include a microprocessor and a microcontroller.

The ACS 110 may store various types of information within the storage unit 113, including, but not limited to information regarding each of the plurality of offline locks 130, identification and/or profile data of authorized users, identification and/or profile data of unauthorized users, commands to control user access to the ACS 110, commands to control user access to the plurality of offline locks 130, commands to control the offline locks 130, status types of the offline locks 130, and programs, code, tables, databases, and any other storage medium and/or method including any of the aforementioned information and/or data. The above information may be programmed or input into the ACS 110 by a user having authorized access.

The transmitter 115 may send signals and information to the lock updater 120, and the receiver 116 may receive signals and information from the lock updater 120.

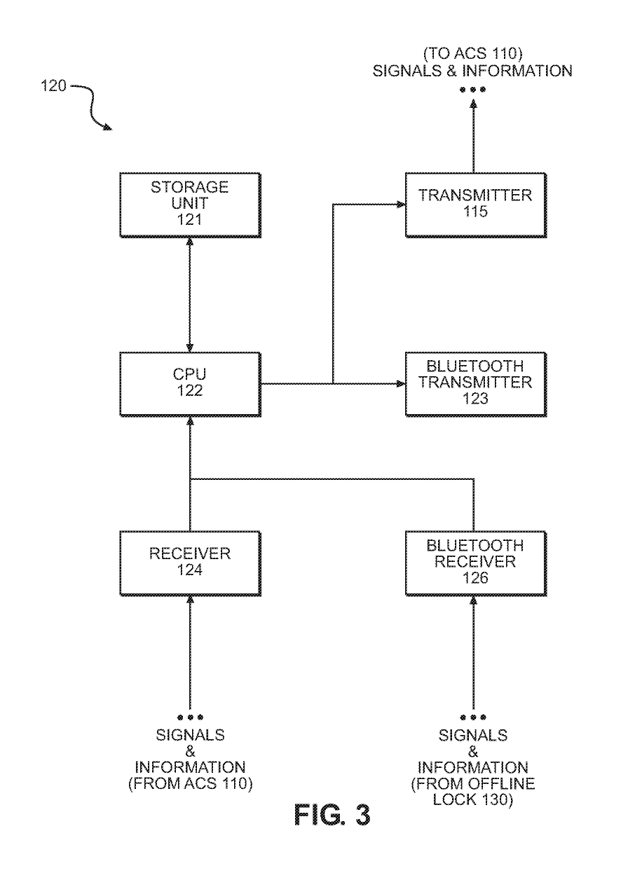

FIG. 3 is a detailed diagram of the lock updater 120 of FIG. 1, according to an exemplary embodiment of the present general inventive concept.

The lock updater 120 may include a storage unit 121, a central processing unit (CPU) 122, a transmitter 123, a receiver 124, a Bluetooth transmitter 125, and a Bluetooth receiver 126.

The storage unit 121 may store data similar to the data stored in the storage unit 113 of the ACS 110.

The CPU 122 may perform controlling functions to determine whether data should be transmitted to the ACS 110 or the offline lock 130.

The transmitter 123 may send signals and information to the ACS 110, and the receiver 124 may receive signals and information from the ACS 110.

The Bluetooth transmitter 125 may send signals and information to the offline lock 130, and the Bluetooth receiver 126 may receive signals and information from the offline lock 130. The Bluetooth transmitter 125 and the Bluetooth receiver 126 may include any type of Bluetooth version, including, but not limited to, BLE.

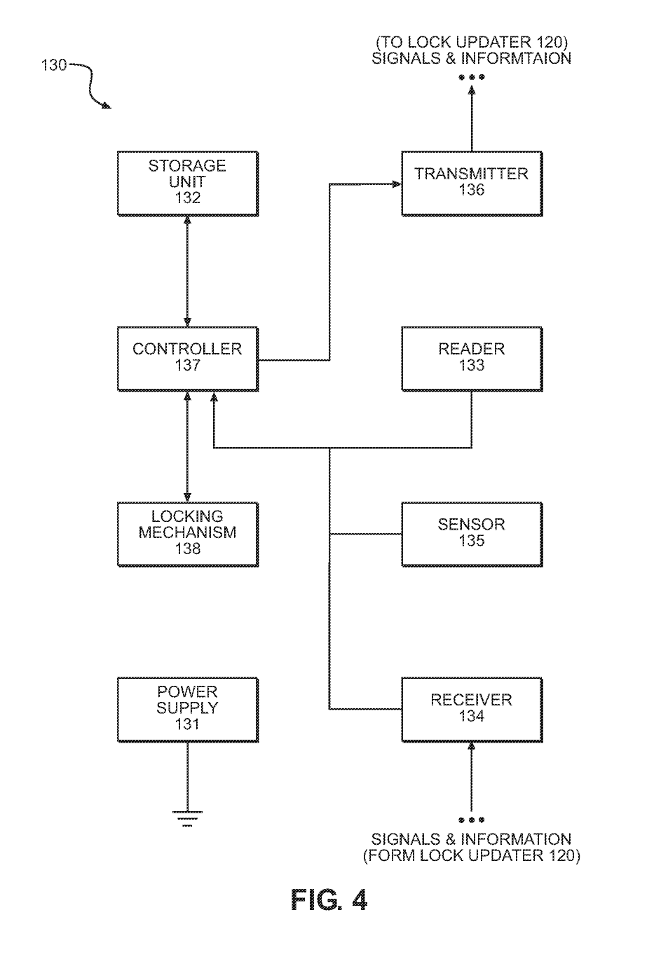

FIG. 4 is a detailed diagram of the offline lock 130 of FIG. 1, according to an exemplary embodiment of the present general inventive concept.

Each of the plurality of offline locks 130 may include a power supply 131, a storage unit 132, a reader 133, a receiver 134, a sensor 135, a transmitter 136, a controller 137, and a locking mechanism 138. The plurality of offline locks 130 may each be attached to a door, window, safe, or any other object that requires security.

The plurality of offline locks may each be powered by the power supply unit 131. The power supply unit 131 may include a removable battery or a plurality of batteries being rechargeable or non-rechargeable, or any other power source to provide power to the plurality of offline locks 130.

The storage unit 132 may include any type of storage device used to store data and information, similar to the storage unit 113 of the ACS 110. The storage unit 132 may store information regarding the offline lock 130, identification and/or profile data of authorized users, identification and/or profile data of unauthorized users, status types of the offline lock 130, and modes of the offline lock 130, but is not limited thereto.

The plurality of offline locks 130 may all operate in a low power mode, which includes a standby mode, an offline mode, or a sleep mode. While the offline lock 130 is in the low power mode, the power supply unit 131 minimizes an amount of power output to the offline lock 130. As such, any batteries comprising the power supply unit 131 drain at a minimal rate, thereby conserving power. Accordingly, the batteries within the power supply unit 131 may last upwards of 2 to 3 years, despite the locks being accessed dozens of times each day.

When the user desires to change a setting, update and/or change access information, etc., of a particular offline lock 130, the user may input a command (e.g., information) into the ACS 110. The ACS 110 may then, through Wi-Fi or Ethernet, access a particular lock updater 120 that is within a BLE range of the particular offline lock 130. The lock updater 120 may then send a signal via BLE to the receiver 134 of the offline lock 130, which causes the offline lock 130 to enter into an online mode. The offline lock 130 may then receive the information from the lock updater 120, thereby allowing the offline lock 130 to be updated with the information the user input into the ACS 110. When the offline lock 130 finishes receiving the information from the lock updater 120, the offline lock 130 returns to the low power mode in order to conserve battery power.

For example, if an administrator desires to change a security-level setting for a particular offline lock 130 from low-level security to high-level security (which would grant access to only particular predetermined authorized users, for example), the administrator may type a corresponding command to change the security-level setting for the particular offline lock 130, into the input device 112 of the ACS 100. Then the transmitter 115 of the ACS 110 may send a signal and information corresponding to the security-level setting change to the lock updater 120 that is within a Bluetooth (or BLE) range of the particular offline lock 130. The Bluetooth transmitter 125 of the lock updater 120 may send a signal and information to the receiver 134 of the offline lock 130. The offline lock 130 “wakes up” in response to receiving the signal transmitted from the Bluetooth transmitter 125 of the lock updater 120, and as a result, the offline lock 130 switches from a low power mode (sleep mode, offline mode, idle mode, etc.) to an online mode to be able to receive the information regarding the changed security-level setting. The offline lock 130 may then store the changed security-level setting information in the storage unit. Subsequently, to preserve battery power, the offline lock 130 switches back to the low power mode.

The offline lock 130 may also be configured to send information to the lock updater 120, based on a user's preferences. For example, the sensor 135 of the offline lock 130 can sense various predetermined conditions of an object (i.e., a door, a window, an elevator, etc.) to which the offline lock 130 is connected. For example, the sensor 135 may sense whether a door is ajar for a particular period of time, and send a signal and information to the lock updater 120, which then in turn may send a signal and information to the ACS 110 to alert the administrator that the door is ajar. Also, the offline lock 130 may be programmed to sense when the power in the batteries is low, and then may send a signal and information to the lock updater 120, which then in turn may send a signal and information to the ACS 110 to alert the administrator that the power in the batteries is low. Furthermore, the offline lock 130 may be programmed in advance to sense when an unauthorized user is attempting to access the offline lock 130, and may send a signal and information to the lock updater 120, which then in turn may send a signal and information to the ACS 110 to alert the administrator that the unauthorized user is attempting to access the offline lock 130.

Nevertheless, the offline lock 130 remains in the low power mode until either the sensor 135 senses the predetermined condition, or the offline lock 130 operates in the online mode. In other words, the offline lock 130 remains in the low power mode until the offline lock 130 enters the online mode.

All signals and information may be sent from the offline lock 130 to the lock updater 120 via the transmitter 136.

The controller 137 may control various components of the offline lock 130. For example, the controller may control the transmitter 136 to transmit information to the lock updater 120, the locking mechanism to lock/unlock the offline lock 130 based on information received from the reader 133, or any other function of the offline lock 130 received by the lock updater 120 in response to a command input by the user at the ACS 110. The controller 137 may include a central processing unit (CPU), or alternatively, may be part of a printed circuit board (PCB).

A plurality of different type of settings may be input into the ACS 110 to control the plurality of offline locks 130, such as a Lockdown setting, a Blacklist setting, a Credential Revalidation Date setting, a Lock Calendars setting, a Time Intervals setting, a Lock Groups setting, but are not limited thereto.

The Lockdown setting, for example, is a setting that may be applied to the plurality of offline locks 130 that causes all the offline locks 130 within the BLE range of corresponding lock updaters 120 to be locked simultaneously, or in a particular order.

The Blacklist setting, for example, is a setting that may be applied to the plurality of offline locks 130 that causes all or selected offline locks 130 within the BLE range of corresponding lock updaters 120 to prevent unauthorized users to access the offline locks 130.

The Credential Revalidation Date setting, for example, is a setting that uses a parameter such as a “Minimum Validation Date,” in order to set information in a lock that will essentially invalidate any credential that has not been updated since a predetermined time. This is like a soft blacklist in that a user can force people to revalidate/update access privileges saved on their personal credentials if an administrator desires to make a sweeping (i.e., all-encompassing) change throughout the system. An example might be that all users receive access to the server room for a year, then later, an administrator desires to put a safe in that room and restrict access. The administrator can change users' access privileges to the lock on the door and set the Minimum Validation Date for that lock to a particular day, such that everyone who wants access to the room will need to update their credentials to get in. In other words, users are forced to perform updates when required.

The Lock Calendars setting, for example, is a setting that may be applied to the plurality of offline locks 130 that causes all or selected offline locks 130 within the BLE range of corresponding lock updaters 120 to remain open or locked during particular predetermined days.

The Time Intervals setting, for example, is a setting that may be applied to the plurality of offline locks 130 that causes all or selected offline locks 130 within the BLE range of corresponding lock updaters 120 to remain open or locked during a particular predetermined time period each day.

The Lock Groups setting, for example, is a setting that may be applied to the plurality of offline locks 130 that will allow users that have access to a particular lock group to gain access to locks that belong to that group. Locks can be added or removed from these groups through the corresponding lock updaters 120.

The lock updater 120 may be provided in plurality on a particular floor of a building in a mesh-type arrangement, in order to ensure that a particular offline lock 130 is accessible and within Bluetooth range of at least one of the lock updaters 120. This also allows an offline lock 130 to be accessible and within range of another lock updater 120, just in case one of the other lock updaters 120 within a Bluetooth range of the offline lock 130 fails.

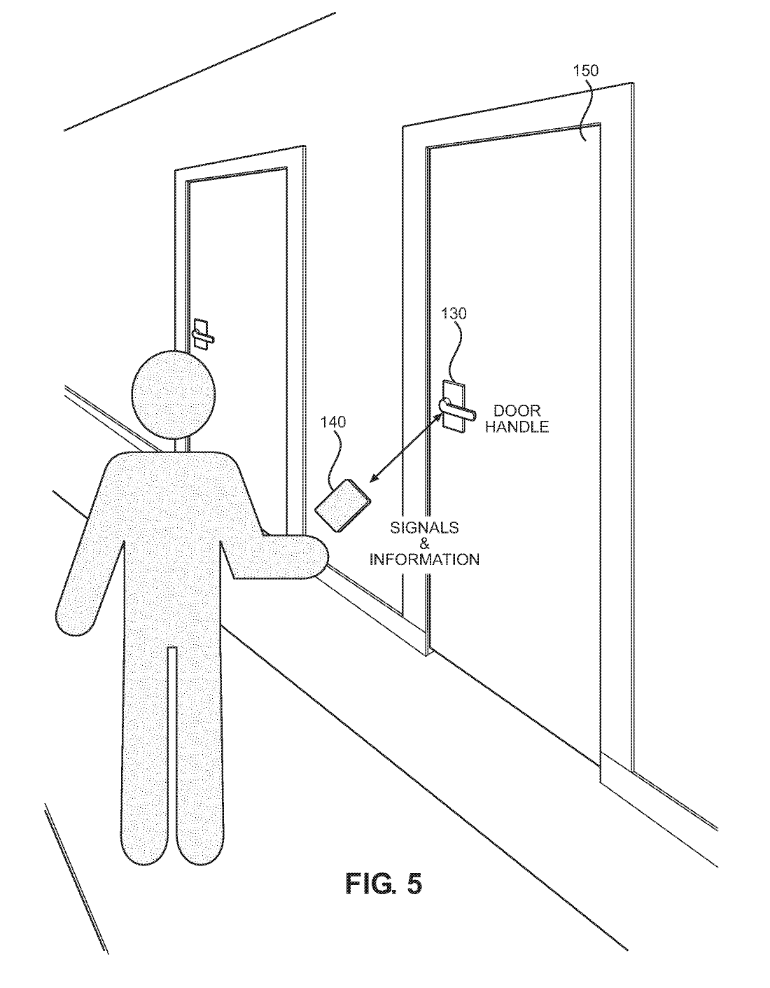

FIG. 5 is a view illustrating the user attempting to electronically open the offline lock 130, according to an exemplary embodiment of the present general inventive concept.

Referring to FIGS. 1, 4 and 5, in order for a user to enter a door 150 locked by the offline lock 130, the user may use an identification object 140, such as a smart card, dongle, key-fob, chip, or access code/information programmed on an application running on a smart phone or other electronic device (such as a computer, laptop, tablet-type computer, etc.), but is not limited thereto. The identification object 140 may include (i.e., be programmed, encoded, magnetized, etc.) an identifying number, code, authentication information, or any other type of data that relevant to a particular user.

When a user desires to enter a room, for example, by using the identification object 140 encoded with the user's identification information, the user must first come within a reader-range of the offline lock 130. The reader-range could be a BLE range or any other type of NFC range, including radio frequency identification (RFID) readers. When the offline lock 130 senses that the identification object 140 is within the reader-range, the controller 137 may decrypt the access privileges from the identification object 140 or access the storage unit 132 to verify whether the user has authorized access to open the offline lock 130. If the user has authorized access to open the offline lock 130, the controller 137 controls the locking mechanism 138 to open in order to allow the user to open the door 150. In this case, all operations performed by the offline lock 130 were done in an “offline” mode.

The identification object 140 may be encrypted by the ACS 110, and may be readable by the offline locks 130 with diversified AES keys. Each installation of an ACS 110 may include a unique key. As such, cards cannot be copied or used between systems accidentally.

Alternatively, if the controller 137 determines that the user does not have authorized access to open the offline lock 130, the offline lock 130 remains locked, and the offline lock may briefly go into an “online” mode in order to send a signal via BLE to the lock updater 120 that an unauthorized user attempted to enter through the door 150. Subsequently, the lock updater 120 may send the information to the ACS 110 via Wi-Fi or Ethernet in order to alert an administrator of the attempted unauthorized access. Accordingly, if the administrator then determines that there has been a security breach or other threat, the administrator can send a “blacklist” command via the ACS 110 to prevent the user from being able to enter any or all doors selected by the administrator.

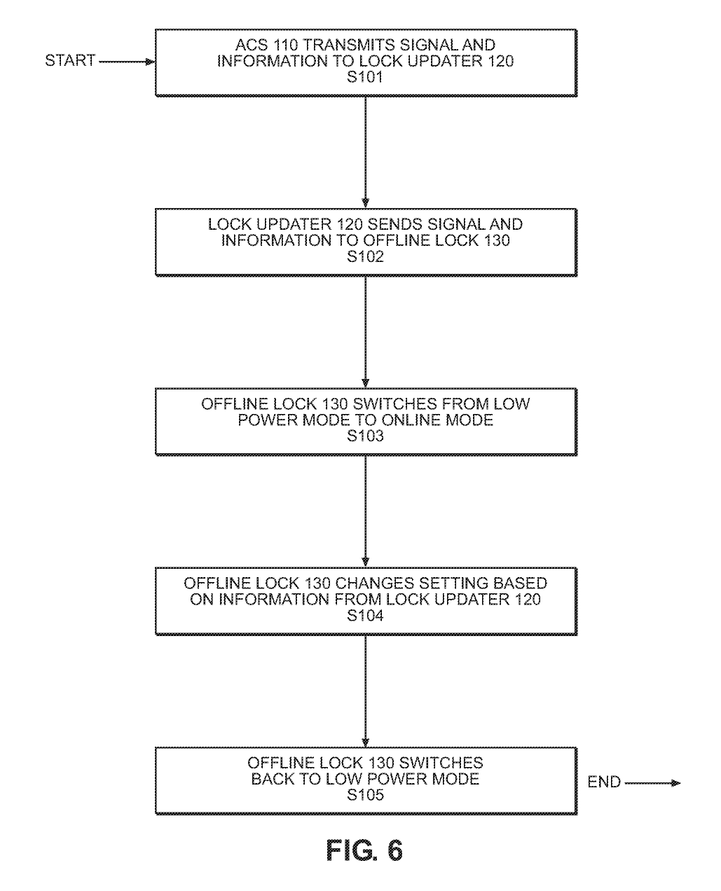

FIG. 6 illustrates a method of changing a setting of at least one of the plurality of offline locks 130 within the offline lock system 100, according to an exemplary embodiment of the present general inventive concept.

Referring to FIG. 6, in S101, the ACS 110 transmits a signal and information to the lock updater 120. In S102, the lock updater 120 sends a signal and information via Bluetooth communication to at least one of the plurality of offline locks 130. In S103, upon receipt of the Bluetooth signal, the at least one of the plurality of offline locks 130 wakes up from a low power mode and switches to an online mode. In S104, the at least one of the plurality of offline locks 130 changes its setting based on the information received from the lock updater 120. In S105, the at least one of the plurality of offline locks 130 switches back to the low power mode. The operations in FIG. 6 are directed to the method of changing a setting of at least one of the plurality of offline locks 130 within the offline lock system 100, but also may pertain to other types of control and/or information distribution to the offline locks 130, not limited to changing only of settings.

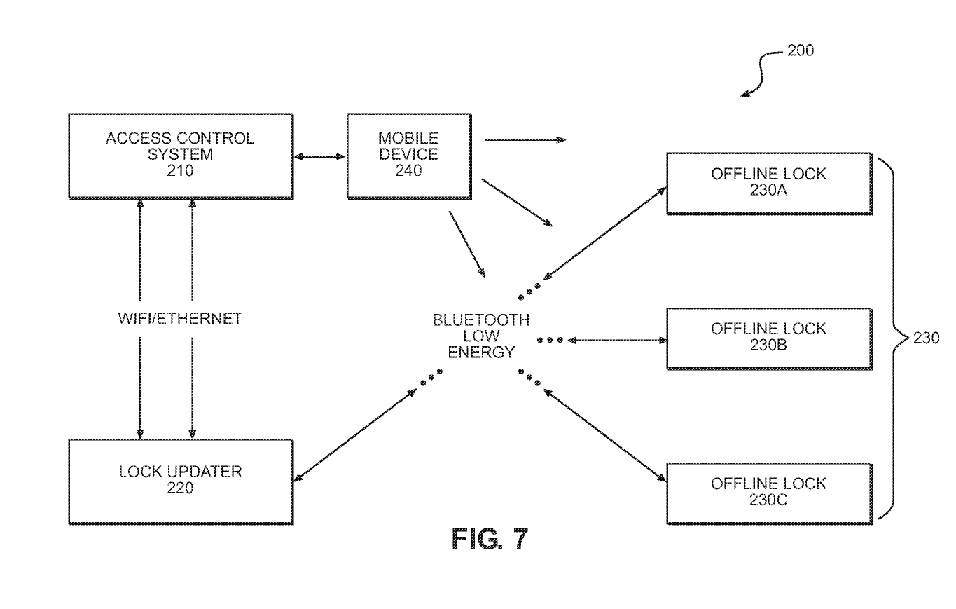

FIG. 7 illustrates an offline lock system 200 according to another exemplary embodiment of the present general inventive concept.

The offline lock system 200 may include an access control system (ACS) 210, a lock updater 220, an offline lock 230, and a mobile device 240.

The ACS 210, the lock updater, and the offline lock 230 may include similar components and may function in a manner as described above with respect to the offline lock system 100. As such, redundant descriptions thereof will be omitted.

The mobile device 240 may be used as a multifunctional device, and may include a smart phone, personal data assistant (PDA), tablet computer, laptop computer, etc., but is not limited thereto. More specifically, the mobile device 240 may include a program or application running thereon, which may send control signals via the Internet, Wi-Fi, or via cloud technology to the ACS 210. More specifically, the mobile device 240 may allow an administrator to access or control the ACS 210 remotely, in order to send commands to the lock updater 220 to change settings, etc., of the offline lock 230.

Additionally, the mobile device 240 may be used similarly as the identification object 140 in order to unlock the offline lock 230 when within a reader range.

The present general inventive concept includes an offline lock system having functionality of an online lock system, while maintaining efficiency and cost-effectiveness of a conventional offline lock system.

The present general inventive concept can also be embodied as computer-readable codes on a computer-readable medium. The computer-readable medium can include a computer-readable recording medium and a computer-readable transmission medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Referring to FIGS. 1 through 7, many different types of software may be used by the ACS 110 (or the mobile unit 140) in order to allow the offline lock system 100 (or the offline lock system 200) to function properly. For example, Android 5.0 or later, or a Linux build are options, but are not limited thereto. Communication with the ACS 110 may use socket connections may be performed over a port chosen by an operator (a.k.a., administrator) of the ACS 110.

ZMQ may be used as an open source socket library written in many languages. The socket communication with the offline lock updater 120 may be encrypted with AES 128 bit encryption. Packages to and from the offline locks 130 will use end to end encryption with different keys. In other words, packages that make it to the lock will be encrypted twice and the offline lock updater 120 will not be able to manipulate the packages sent, but will act as a conduit for connecting to the offline locks over BLE when a lock needs to be updated or values retrieved. Using sockets will also allow us to keep connections open and use bidirectional communication. Since sockets may be used to perform the communication, message serialization must be managed.

Google Protocol Buffers may be used to manage our message serialization across all of the programming languages that may be used to perform the communication. For example, C# may be used for the ACS, C may be used for the Offline Lock, C++ may be used for Other Controllers, Java may be used for Android, and Objective C may be used for iOS. Google Protocol Buffers is open source.

The offline lock updater 120 may expose a custom application program interface (API) to allow the ACS, or other trusted technology, to communicate with BLE devices by defining device attributes, BLE characteristics and byte array packets to send to the device. This allows the offline lock updater 120 to communicate with other BLE devices in the future without having to change the firmware.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An offline lock system, comprising:
at least one offline lock installed on a door to allow the door to lock and unlock;
at least one lock updater disposed within a predetermined range of the at least one offline lock to communicate with the at least one offline lock; and
an access control system to communicate with the at least one lock updater such that the at least one lock updater transmits information to the at least one offline lock to update the at least one offline lock.

2. The offline lock system of claim 1, wherein the at least one offline lock comprises:
a sensor to sense a predetermined condition of at least one of the door and the at least one offline lock;
a receiver to receive a signal including the information from the at least one lock updater; and
a transmitter to transmit a signal with other information to the at least one lock updater.

3. The offline lock system of claim 2, wherein the at least one offline lock switches from a low power mode to an online mode in response to at least one of the sensed predetermined condition and the signal received from the at least one lock updater.

4. The offline lock system of claim 3, wherein the at least one offline lock is updated while in the online mode, and the at least one offline lock switches from the online mode to the low power mode after the update is completed.

5. The offline lock system of claim 3, wherein the transmitter transmits the signal with the other information to the at least one lock updater in response to the sensed predetermined condition, and the at least one lock updater transmits the other information to the access control system.

6. The offline lock system of claim 2, wherein the predetermined condition includes at least one of the door being ajar for a particular time period, batteries within the at least one offline lock having low power, and an unauthorized user attempting to unlock the at least one offline lock.

7. The offline lock system of claim 2, wherein the access control system selects a closest one of the at least one lock updater with respect to the at least one offline lock that requires an update.

8. The offline lock system of claim 1, wherein the at least one lock updater communicates with the at least one offline lock using BLUETOOTH LOW ENERGY (BLE).

9. The offline lock system of claim 1, wherein the access control system comprises:
a storage unit to store at least one of information regarding the at least one offline lock identification and/or profile data of authorized users, identification and/or profile data of unauthorized users, commands to control user access to the access control system, commands to control user access to the at least one offline lock, commands to control the at least one offline lock, status types of the at least one offline lock, and programs to allow control of the at least one lock updater and the at least one offline lock; and
an input unit to allow a user to input information to change a setting of the at least one offline lock, update the at least one offline lock, and change access information of the at least one offline lock.

10. The offline lock system of claim 1, further comprising:
a mobile device to allow a user to access and control the access control system remotely.

11. A method of updating an offline lock system, the method comprising:
transmitting a first signal and first information from an access control system to a selected lock updater;
transmitting a second signal and second information via Bluetooth communication from the selected lock updater to at least one of a plurality of offline locks;
switching the at least one of the plurality of offline locks from a low power mode to an online mode in response to the at least one of the plurality of offline locks receiving the second signal via Bluetooth communication;
updating at least one setting of the at least one of the plurality of the offline locks based on the second information received from the selected lock updater; and
switching the at least one of the plurality of offline locks from the online mode to the low power mode after the update.
